(19) United States
(12) Patent Application Publication
(10) Pub. No.: US 2015/0073894 A1
(43) Pub. Date: Mar. 12, 2015

(54) Suspect Anomaly Detection and Presentation within Context

(71) Applicant: Metamarkets Group Inc., San Francisco, CA (US)

(72) Inventors: Xavier Leaute, San Francisco, CA (US); Nelson Ray, San Francisco, CA (US)

(21) Appl. No.: 14/480,448

(22) Filed: Sep. 8, 2014

Related U.S. Application Data
(60) Provisional application No. 61/874,515, filed on Sep. 6, 2013.

(51) Int. Cl. G06Q 30/02

(52) U.S. Cl. CPC G06Q 30/0248
USPC 705/14.47

(57) ABSTRACT

Events and metrics from time series data are analyzed to detect unexpected spikes and dips or other unpredictable occurrences. In time series measurement of a metric it is not uncommon for a particular metric to have predictable deviations from a median value. For example, activity on a particular “weekday” web site may be more intense during weekdays and have very little activity on weekends. A different web site might have the opposite “normal” activity profile. If the “weekday” web site were to have a large amount of activity on a Saturday and/or Sunday then that large amount of activity may be considered unpredictable and be classified as a “suspect anomaly.” Techniques to identify and novel presentation of suspect anomalies are presented in this disclosure.

### TECHNICAL FIELD

This disclosure relates generally to a system and method for identifying deviations from expected data when analyzing time series data of events and metrics. Time series data represents measurements of a metric at discrete points in time for a given time duration. Time durations can be short (e.g., seconds or sub-second measurements) or can be substantially longer (e.g., hours, days, months or even years). Disclosed techniques can be used to identify a “suspect anomaly” in time series data. A suspect anomaly in a very generic sense can be thought of as an unexpected decline or increase in a metric value relative to historical values for the same metric in a related but different time period. After identification, novel techniques to allow a user to interact with data and have suspect anomalies displayed within the context of their occurrence are disclosed.

### BACKGROUND

Analysis of collected data can be performed in many different ways. A system monitoring activity on a computer network for example may have threshold values that when determined to cross above or below a threshold value can generate an alert to a system administrator to indicate that remedial action may be required. For example, if a disk partition becomes more than 90% full then relocation of data stored on that partition or expansion of the partition may be required. Similarly a metric value falling below a threshold might be an indication that there may be a bottleneck upstream preventing proper throughput in the computer network. Each of these examples refers to analysis of a metric value with respect to a single measurement of that metric. More advanced techniques can be applied to time series data. Time series data refers to measurement of a metric value at periodic intervals over a time span. Periodic intervals can be either regularly spaced in time (e.g., every minute, second, hour, etc.) or can be at irregular time intervals and measured based on occurrence of some event.

This disclosure relates to analysis of time series data for a metric or combination of metrics relative to historical values of the metric (metric combination) when time periods of the historical values are related in some way to each other. Metric combinations include but are not limited to aggregated values or algorithms applied across a plurality of different metrics. Further, once an “unexpected” deviation is identified the unexpected deviation can be classified as a “suspect anomaly” and subjected to further analysis or identified to a user for inspection or informational purposes.

### BRIEF DESCRIPTION OF THE DRAWINGS

FIG. 1 illustrates architecture 100 for one embodiment of a distributed database of time stamped records which could be utilized to support concepts of this disclosure.

FIG. 2 is a block diagram 200 illustrating a computer with a processing unit which could be configured to facilitate one or more functional components according to one or more disclosed embodiments.

FIG. 3 is a screen shot 300 of one example of a Discovery Feed display including “sparklines” used to display the general shape of metric values and their variation over time according to one or more disclosed embodiments.

FIG. 4 illustrates a dashboard view 400 presented to allow further analysis of a selected (e.g., by a user) suspect anomaly from the Discovery Feed of FIG. 3 according to the one or more disclosed embodiments.

FIG. 5 illustrates another example view 500 of a Discovery Feed display.

FIG. 6A illustrates another example view 600 of a dashboard corresponding to one suspect anomaly selection from FIG. 5.

FIG. 6B illustrates in view 650 an enlarged portion of view 600 from FIG. 6A.

FIG. 7 shows a flow chart 700 for one method of allowing a user to interact with the Discovery Feed of FIG. 3 to allow further analysis via the dashboard of FIG. 4 according to one or more disclosed embodiments.

### DETAILED DESCRIPTION

The concepts of this disclosure could relate to any industry where identification of suspect anomalies in time series data could be relevant. As explained above a suspect anomaly refers to an unexpected deviation from normal behavior relative to a related time period or related metrics associated with the metric being analyzed (e.g., same metric for business competitor(s) or industry group average). A related or different time period could be thought of as each afternoon versus morning in a particular time zone or weekend versus weekday. Also a day falling on a Holiday in one year would be related to that same Holiday in a different year. Yet another related time period could be defined as the set of days that are considered Holidays. Any logical correlation between time periods might allow them to be classified as related time periods within the context of this disclosure and may be determined based on the type of metric value or event being collected in the time series data. This disclosure will be described generally but where specific examples of specific metrics are used they will be described in the context of monitoring Internet advertising where publishers, ad exchanges, and ad servers work together to supply a real-time digital marketplace of real-time bidding (RTB) to provide targeted on-line advertising to web browsers associated with users surfing the Internet.

Anomalies can be detected either vertically or horizontally. A vertical anomaly refers to a metric whose value over a time period reflects that the value deviates from its own expected value. A horizontal anomaly refers to a metric whose value over a time period deviates from other metrics with which it typically trends. For example, metrics collected across an industry segment should loosely track increases as the market segment grows as a whole. Also, a vertical anomaly might encompass a sudden unexpected spike in revenue for a given retailer in an industry. This could also be classified as a horizontal anomaly except in the case of an industry-wide boom.

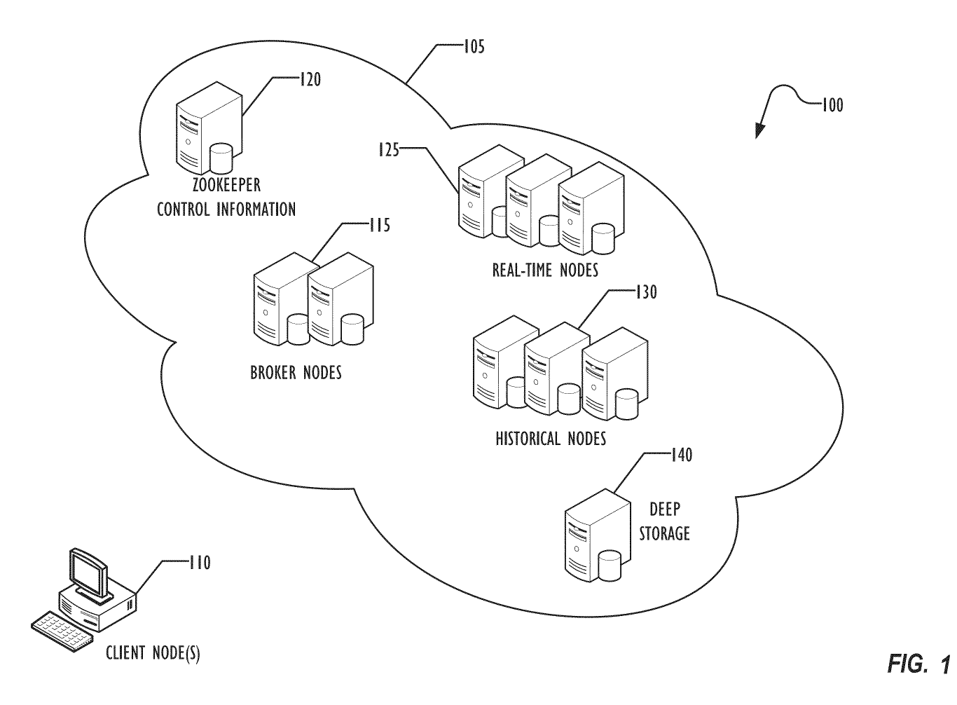

Referring to FIG. 1, architecture 100 illustrates resources to provide infrastructure for a distributed data base of time stamped records according to one or more disclosed embodiments. Cloud 105 represents a logical construct containing a plurality of machines configured to perform different roles in a support infrastructure for the distributed data base of time stamped records. Cloud 105 is connected to one or more client nodes 110 which interact with the resources of cloud 105 via a network connection (not shown). The network connection can be wired or wireless and implemented utilizing any kind of computer networking technique. Internal to cloud 105 are various servers and storage devices (e.g., control information 120, broker nodes 115, real-time nodes 125, historical nodes 130, and deep storage 140) configured to perform individually distinct roles when utilized to implement management of the database of time stamped records. Each of the computers within cloud 105 can also be configured with network connections to each other via wired or wireless connections as required. Typically, all computers are capable of communicating with all other computers however, based on their role each computer may not have to communicate directly with every other computer. The terms computer and node are used interchangeably throughout the context of this disclosure. Additionally references to a single computer could be implemented via a plurality of computers performing a single role or a plurality of computers each individually performing the role of the referenced single computer (and vice versa). Also, each of the computers shown in cloud 105 could be separate physical computers or virtual systems implemented on non-dedicated hardware resources.

Broker nodes 115 can be used to assist with external visibility and internal coordination of the disclosed data base of time stamped records. In one embodiment, client node(s) 110 interact only with broker nodes (relative to elements shown in architecture 100) via a graphical user interface (GUI). Of course, a client node 110 may interact directly with a web server node (not shown) that in turn interacts with the broker node. However, for simplicity of this disclosure it can be assumed that client node(s) 110 interact directly with broker nodes 115. Broker nodes 115 can interact with “zookeeper” control information node 120 to determine exactly where the data is stored that is responsive to the query request. Data can be stored in one or more of real-time nodes 125, historical nodes 130, and/or deep storage 140. Broker nodes 115 and historical nodes 130 can be considered a general class of a compute node to perform analysis of historical data and detect anomalies in the stored data according to the disclosed embodiments. Additionally, analysis nodes (not shown) could be added to architecture 100 to perform the analysis functions disclosed. For more information about an example architecture to support a distributed database of time stamped records (e.g., time series data) can be found in U.S. patent application Ser. No. 14/444,888 filed 28 Jul. 2014 entitled “Segment Data Visibility and Management in a Distributed Data Base of Time Stamped Records” by Yang et al. which is incorporated by reference in its entirety.

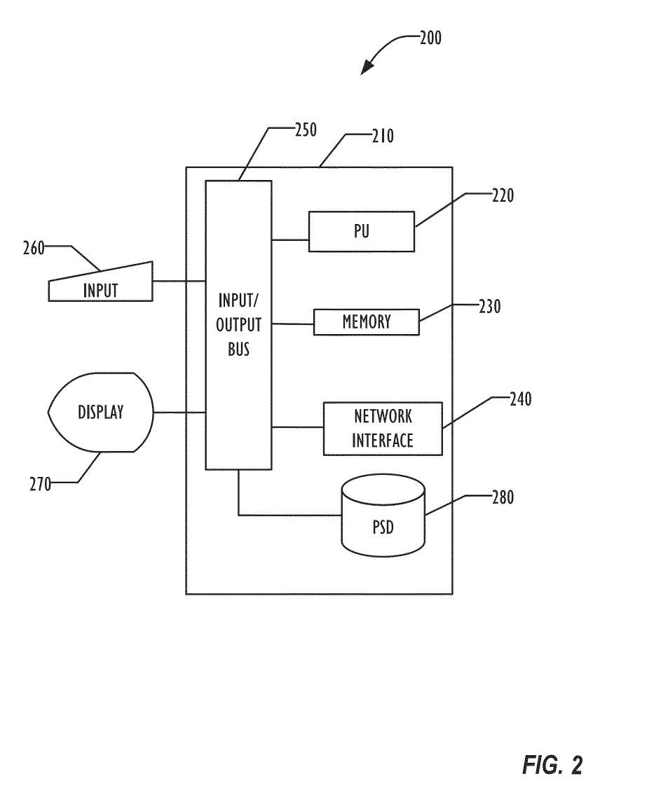

Referring now to FIG. 2, an example processing device 200 for use in providing disclosed anomaly detection techniques according to one embodiment is illustrated in block diagram form. Processing device 200 may serve as processor in a gateway or router, client computer 110, or a server computer (e.g., 115, 120, 125, 130 or 140). Example processing device 200 comprises a system unit 210 which may be optionally connected to an input device for system 260 (e.g., keyboard, mouse, touch screen, etc.) and display 270. A program storage device (PSD) 280 (sometimes referred to as a hard disc, flash memory, or computer readable medium) is included with the system unit 210. Also included with system unit 210 is a network interface 240 for communication via a network (either wired or wireless) with other computing and corporate infrastructure devices (not shown). Network interface 240 may be included within system unit 210 or be external to system unit 210. In either case, system unit 210 will be communicatively coupled to network interface 240. Program storage device 280 represents any form of non-volatile storage including, but not limited to, all forms of optical and magnetic memory, including solid-state, storage elements, including removable media, and may be included within system unit 210 or be external to system unit 210. Program storage device 280 may be used for storage of software to control system unit 210, data for use by the processing device 200, or both.

System unit 210 may be programmed to perform methods in accordance with this disclosure. System unit 210 comprises one or more processing units (represented by PU 220), input-output (I/O) bus 250, and memory 230. Memory access to memory 230 can be accomplished using the communication bus 250. Processing unit 220 may include any programmable controller device including, for example, a mainframe processor, a cellular phone processor, or one or more members of the Intel Atom®, Core®, Pentium® and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company). Memory 230 may include one or more memory modules and comprise random access memory (RAM), read only memory (ROM), programmable read only memory (PROM), programmable read-write memory, and solid-state memory. PU 220 may also include some internal memory including, for example, cache memory or memory dedicated to a particular processing unit and isolated from other processing units for use in maintaining monitoring information for use with disclosed embodiments of rootkit detection.

Processing device 200 may have resident thereon any desired operating system. Embodiments of disclosed detection techniques may be implemented using any desired programming language, and may be implemented as one or more executable programs, which may link to external libraries of executable routines that may be supplied by the provider of the detection software/firmware, the provider of the operating system, or any other desired provider of suitable library routines. As used herein, the term “a computer system” can refer to a single computer or a plurality of computers working together to perform the function described as being performed on or by a computer system.

In preparation for performing disclosed embodiments on processing device 200, program instructions to configure processing device 200 to perform disclosed embodiments may be provided stored on any type of non-transitory computer-readable media, or may be downloaded from a server onto program storage device 280. It is important to note that even though PU 220 is shown on a single processing device 200 it is envisioned and may be desirable to have more than one processing device 200 in a device configured according to disclosed embodiments.

Discovery Feed

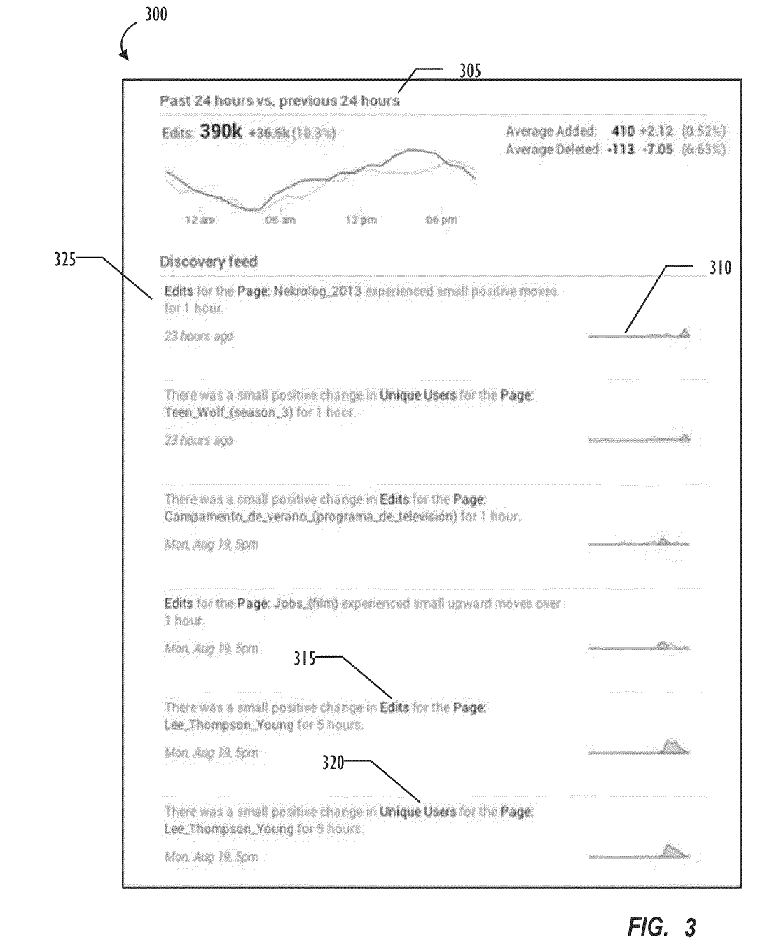

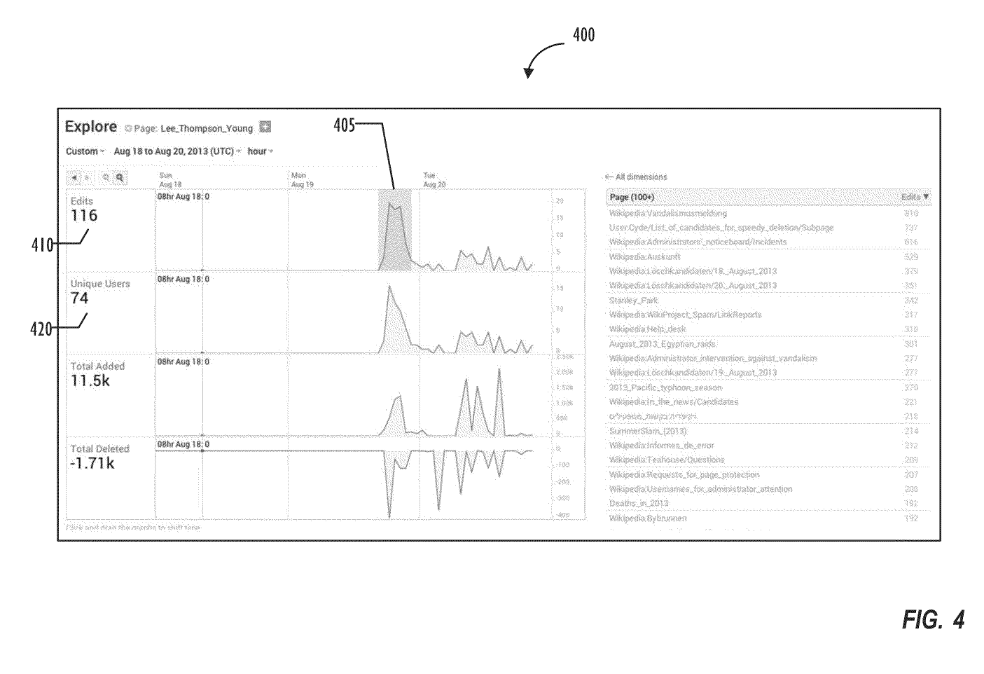

With reference to FIGS. 3 and 4, view 300 illustrates one example of a Discovery Feed showing results of suspect anomaly detection analysis by time with expected anomalies in data eliminated. In this case the analysis is focused on parameters associated with activity on the popular web site Wikipedia. Analysis parameters for different types of anomaly detection can be pre-defined over different durations. In this example data is shown comparing two different 24 hour periods (305). The data reflects the number of edits and number of unique users performing edits on different pages of Wikipedia. A Discovery Feed view can be used to identify nonrecurring spikes or dips for example by displaying a chronological view of “interesting” (e.g., suspect) anomalies to a user. Further, when a particular suspect anomaly is selected the identified “suspect” anomaly can be displayed on the dashboard in the context of all the original data before analysis. On the Dashboard view the duration of the suspect anomaly can be automatically highlighted. This allows a user to quickly get a picture of the anomaly in the context of all the data for a time period possibly greater than the time period in which the suspect anomaly occurred.

Sparklines

Identifying events out of context can be difficult, so the Discovery Feed can also display a “sparkline” 310 next to the event description 325. A sparkline is a small time series graph, devoid of any specific scale or annotations, displaying the metric of interest around the time the event occurred. The sparkline can display the anomalous period highlighted in a different color. To visually identify a spike, the area underneath the time series line can be filled. Similarly, for dips the area above the time series line can be filled. Thus highlighting the direction of the event as shown, for example, by sparkline 310. The sparkline graph 310 can scaled based on the score of the event to make larger events more prominent than smaller ones. In general, sparklines 310 can assist a user by making it easier to scan through the list of events and quickly visualize both the size and the duration of the anomalous event within a long list.

Direct Linking to the Dashboard

Each event 325 in the Discovery Feed can link directly the relevant period of time in the user Dashboard. When a user clicks on an event in the Discovery Feed, the interface can be used to display a corresponding time period in the Dashboard where the anomalous event can be highlighted within the context of values before and after the anomalous period. The highlighted time series can automatically reflect the combination of dimension values for which the event has occurred. For instance, in the case of a revenue spike for a given country, the Dashboard can automatically show and highlight the revenue time series for that particular country only.

Elements 315 and 320 in FIG. 3 show two different metrics with identified suspect anomalies in the given time period. Element 315 identifies a small increase in edits for a particular web page. Element 320 identifies a positive change in unique users editing that particular web page. Upon selection of element 315 a corresponding dashboard view (400) can be displayed. Dashboard View 400 shows details corresponding to element 315 of FIG. 3 at element 410. Dashboard View 400 also shows details corresponding to element 320 of FIG. 3 at element 420. Note that area 405 of FIG. 4 shows an automatically highlighted suspect anomaly as a result of the user selecting corresponding element 315 to cause transition to dashboard view 400. In this manner a user can see the context of the suspect anomaly with graphical data reflecting activity prior to and after the suspect anomaly's duration.

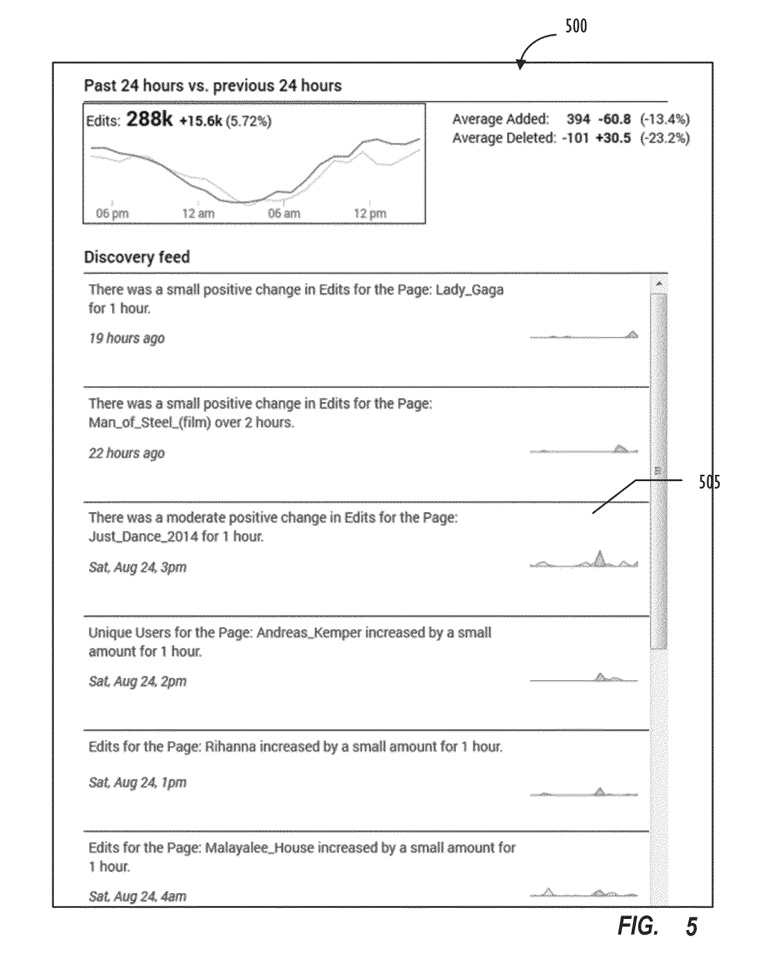

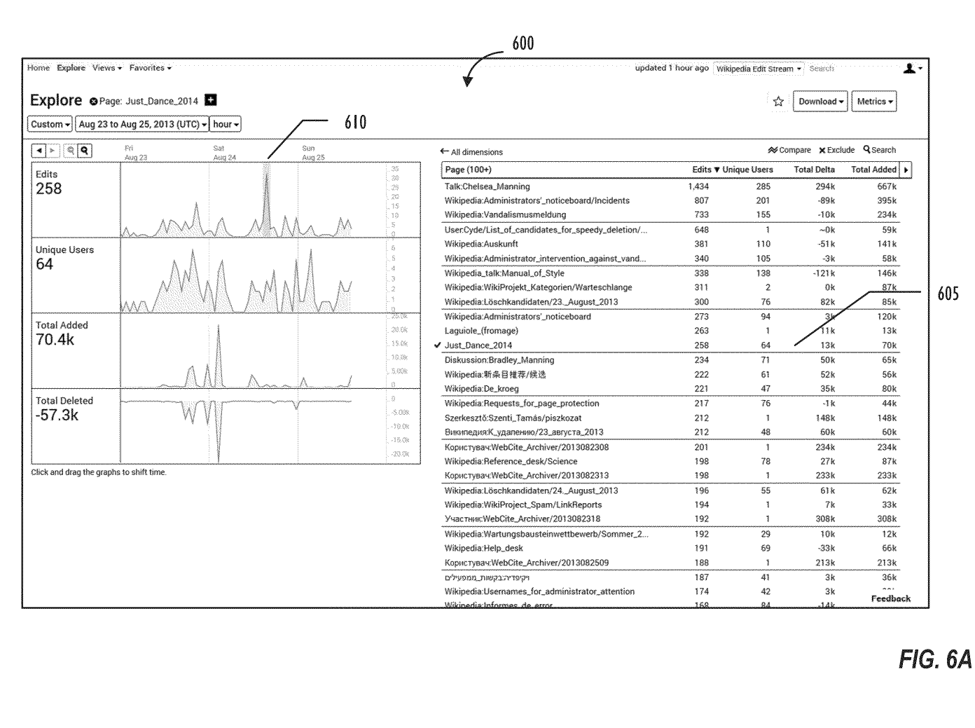

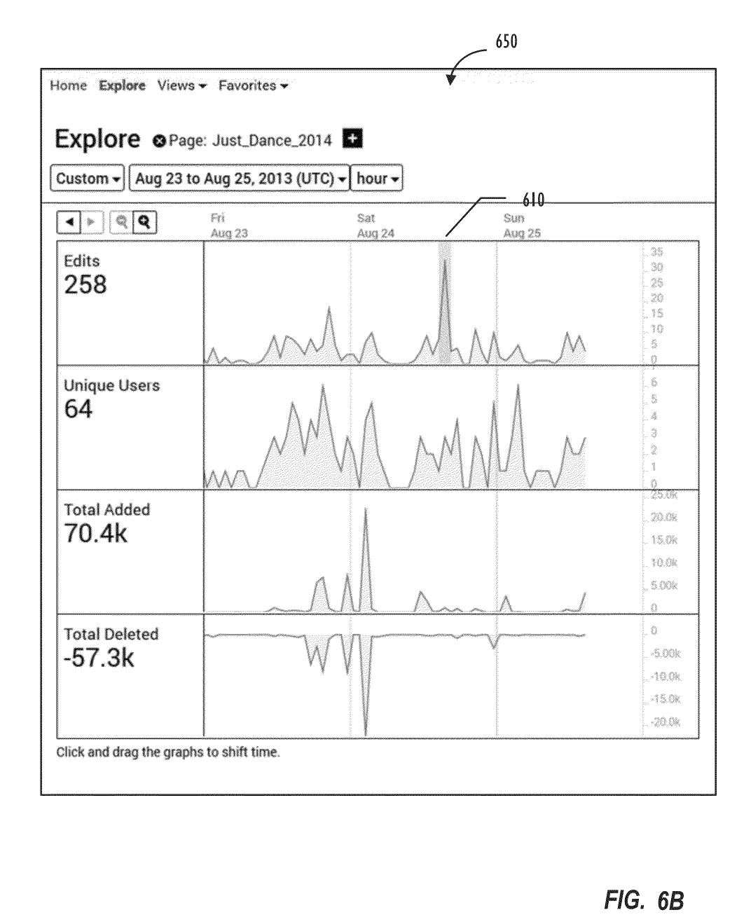

FIGS. 5-6B illustrate another example of a Discovery Feed view 500 and a corresponding display of a Dashboard View 600 based upon user selection of identified suspect anomaly 505. Note that in FIG. 6A the metric for which the suspect anomaly was detected is shown (element 605) within the context of many other metrics reflecting the same attributes being measured for this examples pre-determined metric analysis factors. Also, the suspect anomaly is automatically highlighted and put into context 610. FIG. 6B shows an enlarged view 650 for the left hand portion of view 600.

Multi-Level Analysis

Disclosed techniques allow a user to explore time series metrics at multiple levels, across many dimensions (attributes), each of which can have an arbitrary number of dimension values. For instance, internet advertising revenue metrics can be broken down by country, advertiser, website, or any combination of those dimensions, each of which can have between a handful and millions of possible values.

The Discovery Feed analyzes time series data across multiple dimensions to identify events not only at the high level—e.g. a spike in total revenue by hour—but also for specific dimensions—e.g. spike in revenue for some country—or combinations thereof—e.g. a dip in revenue for any combination of site and advertiser. The depth at which this analysis is done can be adjusted in several ways to keep computations time reasonable, i.e. on the order of a few minutes. In an embodiment, the number of dimension combinations may be varied. The Discovery Feed can analyze combinations of values between 0 dimensions (e.g. total revenue), 1 dimension (e.g. revenue by country) and 2 dimensions (e.g. revenue for each combination of country and website). In another embodiment, the number of dimension values to consider within each dimension may be varied. In order to keep results relevant, the analysis can be concentrated on the top 100 to 200 most frequently occurring values for each dimension. In yet another embodiment, user-specific combinations can also be added based on the interest of the user or recommendations based on their past behavior. Combinations of two or more of these embodiments may be used.

A typical dataset will usually result in the analysis of several thousand combinations. For each of those combinations of dimension values, the Discovery Feed can analyze the time series for all metrics of interest to the user (e.g. revenue, ad impressions, eCPM, etc.).

Differentiating Between Expected and Anomalous Events

One objective of the Discovery Feed is to differentiate between expected variations and unexpected ones in time series data (i.e., suspect anomalies). For instance, if advertising revenue across websites were analyzed, some sites would repeatedly experience dips (i.e., decreases) in revenue on the weekend, while others may generally spike over that same period. Because those are recurring patterns, those events should not be considered unusual. However if we see a spike in revenue on a weekend for a site that typically displays low revenue on weekends, the Discovery Feed should flag it as unusual. Because we cannot distinguish a priori between those sites, the Discovery Feed can analyze each time series independently and look at several weeks of historical data in order to infer what the expected baseline pattern should be for a particular metric value.

A statistical technique called Robust Principal Component Analysis (Robust PCA) can be used to establish the baseline pattern and determine whether any deviations from the baseline should either be classified as noise or be considered anomalous. Any deviation that is statistically significant can be flagged as anomalous by the Discovery Feed. There exist many Robust PCA algorithms, but there are multiple parameters that need to be adjusted in order to yield good results. Prior art techniques suggest informed choices for mu and lambda, but these depend on an unknown parameter sigma (the noise level in the data) and prior art techniques do not suggest any methods to estimate the sigma parameter. In one embodiment of this disclosure a novel method of estimating the sigma parameter is used. This method includes supplying an initial estimate and then iteratively updating it automatically. More specifically, the median absolute deviation on the raw data can be used for the initial estimate of sigma. This is a robust and consistent estimator of the standard deviation of the noise distribution as sigma. This estimate improves on a sample standard deviation estimator because the raw data is typically fraught with outliers. If the sample standard deviation were used, the result would overestimate sigma and over shrink the components in the L and S matrices. In this embodiment, the median absolute deviation is used to estimate the residual noise for each iteration. For more information about Robust PCA please refer to “Robust Principal Component Analysis” by Candes et al. Published December 17, 2009, a copy of which is provided with this disclosure. Also see “Stable Principal Component Pursuit” by Zhou et al. dated January 14, 2010, a copy of which is provided with this disclosure.

Displaying Events of Interest

The Discovery Feed can show both recent and relevant events to the user and make this information easy to consume. However, the Discovery Feed will usually identify a large number of events, some of which are more pronounced than others. Several techniques can be used to reduce the information overload from a user's perspective and allow the user to focus on meaningful events by making it easier to identify events visually.

Event Scoring

Each event detected can be given a relevance score, the relevance score can be based on the following two factors. First, the statistical significance of the anomaly can be used such that stronger, more unusual events receive a higher score than smaller discrepancies. Second, how large the discrepancy compares to other variations within the same set of dimensions can be used to ensure that events that seem highly anomalous when taken out of context do not get a disproportionately large score, if the discrepancies are small within the context of a given set of dimensions. For example, a website with very low revenue may see a large jump from $1 to $50 per day, but when most websites generate around $1000 per day, this is a comparatively small change, and in that context, the relevance score can be reduced.

In one embodiment, an event is only displayed to the user once its score exceeds a certain threshold. This threshold can vary depending on the nature of the data and the frequency at which the analysis is run (daily, hourly, by minute, or by second). The threshold can be determined empirically for each user, and can be customized depending on how much information a user would like to see.

Focus on Recent Data

In order to focus on recent events, event scores can be decayed over time. The event score can be decayed exponentially based on the amount of time that has passed since the event. This technique can help to ensure that high scoring events stay visible for longer periods of time and low scoring events are only shown if they happened very recently.

Human Readable Descriptions

In one disclosed embodiment, each event in the Discovery Feed is given a human readable description in the form of a full sentence to make the interface more readable. This can make the event more meaningful to a user rather than just displaying raw scores. To make event descriptions more interpretable, more subjective quantifiers such as large, small, and moderate can be used to quantify the relative size of the event as opposed to numerical scores when displaying to the user. To assist the user in being able to quickly identify results of interest, each sentence can have different highlighted fields such as but not limited to the relevant metric, dimension, and dimension value as well as the amount of time the event lasted. For example, the following event description could be displayed in the Discover Feed with a sentence like: “Ad revenue for the Country UA has increased by a large amount for 2 hours.” Please see elements 315 and 320 of FIG. 3.

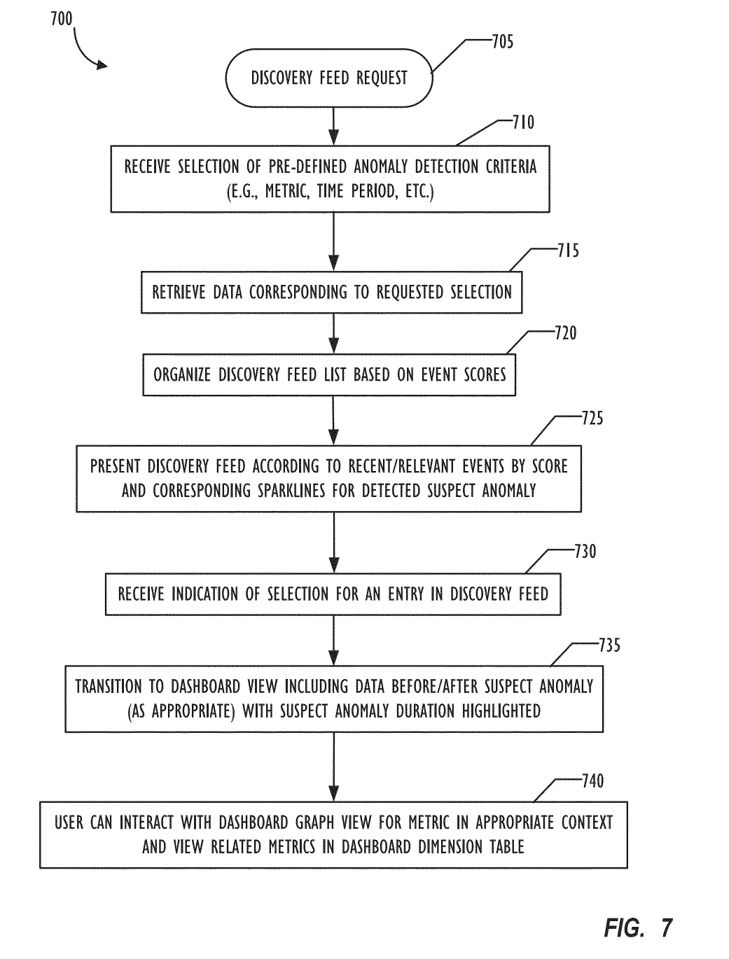

With reference to FIG. 7, flow chart 700 illustrates one method to allow user interaction within the disclosed Discovery Feed view and a corresponding dashboard view for an identified and selected suspect anomaly as determined by the disclosed techniques. Beginning at 705 a request is received to display a particular Discovery Feed view. As explained above, different parameters and metrics can be defined for a plurality of different Discovery Feed views so that suspect anomalies can be detected as either horizontal or vertical anomalies relative to a user's interest. After receipt of a request to display a Discovery Feed (block 710), the data corresponding to identified suspect anomalies can be retrieved (block 715). To better present the identified suspect anomalies to a user each identified event can be organized based on a determined event score (block 720) and the Discovery Feed view could be presented to a user according to relevance and timeliness along with sparklines to assist a user when visually interpreting the data (block 725). If a user selects an entry in the Discovery Feed view (block 730) a corresponding dashboard view (relative to the specifically selected anomaly) can be displayed with proper visual cues to identify the duration of the suspect anomaly (block 735). After display, the dashboard view can allow a user to interact with the data from different metrics directly associated with the anomalous metric or see information about other data sources being analyzed in a similar manner (block 740).

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A non-transitory computer readable medium comprising computer executable instructions stored thereon to cause one or more processing units to:
present a plurality of suspect anomalies detected for one or more metrics in time series data as user selectable indications for each detected suspect anomaly in a given metric;
receive an indication of selection of one of the user selectable indications for a first metric having a suspect anomaly for a first time range; and
present a contextual time series display of the first metric and time series data for the first metric for a first period, the first period reflecting a period before and after the first time range, wherein the first time range is highlighted relative to the first period.

2. The non-transitory computer readable medium of claim 1, wherein the time series data is sampled at regularly spaced time intervals.

3. The non-transitory computer readable medium of claim 1, wherein a suspect anomaly is identified when the given metric value deviates by an amount greater than a threshold value from an expected value for the given metric.

4. The non-transitory computer readable medium of claim 3, wherein the expected value is based on historical data for the given metric.

5. The non-transitory computer readable medium of claim 3, wherein the expected value is based on historical data for a second metric with which the given metric historically correlates.

6. The non-transitory computer readable medium of claim 3, wherein the threshold value for the given metric varies based on at least one of a type of metric of the given metric and a sampling interval of the given metric.

7. The non-transitory computer readable medium of claim 1, wherein the instructions to present a plurality of suspect anomalies detected for one or more metrics in time series data as user selectable indications for each detected suspect anomaly in a given metric comprise instructions to:
display a time series graph displaying each metric around the time the suspect anomaly occurred.

8. The non-transitory computer readable medium of claim 1, wherein each suspect anomaly corresponds to a subset of the time series data for a given metric.

9. The non-transitory computer readable medium of claim 1, wherein one or more of the metrics monitors aspects of internet advertising.

10. A non-transitory computer readable medium comprising computer executable instructions stored thereon to cause one or more processing units to:
receive an initial estimate of a median absolute deviation of a plurality of values of metric data, the plurality of values collected over a period of time;
update the initial estimate to be an iterative estimate and iteratively update the iterative estimate of the median absolute deviation to estimate residual noise for each iteration; and
determine suspect anomalies for a time range in the plurality of values of metric data using the iterative estimate.

11. The non-transitory computer readable medium of claim 10, wherein the instructions to determine suspect anomalies for a time range in the plurality of values of metric data comprise instructions to:
calculate a score based on the iterative estimate; and
identify a suspect anomaly when the score is greater than or equal to a threshold value.

12. The non-transitory computer readable medium of claim 10, further comprising instructions to:
present each suspect anomaly as a user selectable indication.

13. A non-transitory computer readable medium comprising computer executable instructions stored thereon to cause one or more processing units to:
receive time series data for a metric;
identify a plurality of dimensions of the metric, wherein each dimension comprises a subset of the time series data for the metric; and
identify suspect anomalies in the time series data for at least one of the metric, a single dimension, and a combination of two or more dimensions.

14. The non-transitory computer readable medium of claim 13, wherein the instructions to identify suspect anomalies in the time series data for at least one of the metric, a single dimension, and a combination of two or more dimensions further comprise instructions to:
receive a specified combination of two or more dimensions.

15. The non-transitory computer readable medium of claim 13, wherein the instructions to identify suspect anomalies in the time series data for at least one of the metric, a single dimension, and a combination of two or more dimensions further comprise instructions to:
identify a combination of two or more dimensions based on past user behavior.

16. The non-transitory computer readable medium of claim 13,
wherein the dimensions are pre-defined over different durations.

17. The non-transitory computer readable medium of claim 13, wherein the instructions to identify suspect anomalies in the time series data for at least one of the metric, a single dimension, and a combination of two or more dimensions further comprise instructions to:
analyze a subset of time series data for each dimension comprising the most frequently occurring values for suspect anomalies.

18. The non-transitory computer readable medium of claim 17, wherein the most frequently occurring values are the 100-200 most frequently occurring values.

19. The non-transitory computer readable medium of claim 13, wherein the metric is based on internet advertising revenue.

20. The non-transitory computer readable medium of claim 19, wherein the dimensions include one or more of advertising revenue by country, advertising revenue by advertiser, and advertising revenue by website.
